(19) United States
(12) Patent Application Publication
(10) Pub. No.: US 2015/0332208 A1
(43) Pub. Date: Nov. 19, 2015

(54) Automatic Inventory Management System

(71) Applicant: Dealer Dot Com, Inc., Burlington, VT (US)

(72) Inventors: Chris Scott, Williston, VT (US); Adam Burnett, South Burlington, VT (US); Richard Gibbs, Shelburne, VT (US); Jai Paul Macker, Burlington, VT (US); Jonathan Phillips, Shelburne, VT (US); Jeffrey Pierce, Westford, VT (US); Joseph James Pistell, Brewerton, NY (US); Alexander Garth Snyder, Burlington, VT (US)

(73) Assignee: DEALER DOT COM, INC., Burlington, VT (US)

(21) Appl. No.: 14/238,151

(22) PCT Filed: Feb. 6, 2014
(86) PCT No.: PCT/US14/15119

§ 371 Date: Feb. 10, 2014

Related U.S. Application Data
(60) Provisional application No. 61/762,279, filed on Feb. 7, 2013.

(51) Int. Cl. G06Q 10/08

(52) U.S. Cl. CPC G06Q 10/087

(57) ABSTRACT

A method for a dealer to manage products in an inventory includes providing an interface and a processor. The interface is connected for communication with the processor. The interface and the processor are configured so the dealer can provide a plurality of rules through the interface for running on the processor. The processor is configured for running a program for applying the rules to input information that may be provided to the processor regarding a product in the inventory. Outputs of the running the program applying the rules include at least one merchandising action regarding a product in the inventory. The processor is connected to automatically receive the input information and the processor is configured for running a program to automatically implement the at least one merchandising action resulting from applying the rules to the input information.

### FIELD

This patent application generally relates to a programmable computer system for providing automatic inventory management to a dealer of products for sale to consumers. More particularly, it relates to a system that automatically receives and uses market information and takes merchandising actions.

### BACKGROUND

Dealers, such as car dealerships, department stores, real estate agencies, and vendors of many other products on the internet have addressed product inventory by adjusting advertising, incentives, and prices. But they have had no automatic system for doing so, and a better scheme is needed. Such solutions are provided by the following description.

### SUMMARY

One aspect of the present patent application is a method for a dealer to manage products in an inventory. The method includes providing an interface and a processor. The interface is connected for communication with the processor. The interface and the processor are configured so the dealer can provide a plurality of rules through the interface for running on the processor. The processor is configured for running a program for applying the rules to input information that may be provided to the processor regarding a product in the inventory. Outputs of the running the program applying the rules include at least one merchandising action regarding a product in the inventory. The processor is connected to automatically receive the input information and the processor is configured for running a program to automatically implement the at least one merchandising action resulting from applying the rules to the input information.

Another aspect of the present patent application is a system for managing pricing and advertising of products in an inventory for a dealer in which the advertising is in an advertising medium. The system includes a processor connected to receive an input information regarding a product in the inventory. The processor is configured to run a program to apply a rule to the input information. The rule regards at least one from the group consisting of adjusting product pricing and placing product advertising based on the input information. The processor is programmed and connected to automatically implement a change in product pricing and the processor is connected to automatically place a product advertisement in the advertising medium.

Another aspect of the present patent application is a system for managing products in an inventory for a dealer. The system includes a processor connected to automatically receive input information regarding a business condition for a product in the inventory. The processor is connected to run a program to automatically select from a plurality of merchandising actions for the product based on the input information regarding a business condition for the product. The processor is connected to automatically adjust at least one of the merchandising actions based on the input information.

Another aspect of the present patent application is a system for managing products in an inventory for a dealer, comprising a processor, a dealer interface, and a database. The processor is connected to the dealer interface and to a source of input information. The processor is connected for adjusting merchandising actions. The dealer interface is configured for a dealer to enter rules into the database. The dealer interface is configured to display how merchandising actions for members of the inventory change with time under the rules.

Another aspect of the present patent application is a system for managing products in an inventory for a dealer, comprising an interface and a processor. The interface is connected for communication with the processor. The interface and processor are configured so the dealer can provide a plurality of rules through the interface for running on the processor. The processor is connected to automatically receive input information. The processor is configured for running a program for applying the rules to the input information that may be provided to the processor, in which outputs of applying the rules to the input information include merchandising actions regarding a product in the inventory. The processor is programmed and connected to automatically implement at least one of the merchandising actions resulting from applying the rules to the input information.

Another aspect of the present patent application is a system for managing products in an inventory for a dealer, comprising a processor connected to automatically receive input information regarding a product in the inventory. The processor is connected to run a program to automatically apply a rule to the input information. The processor is connected to run a program to automatically determine whether a next future application of the rule is planned. If a next future application of the rule is planned for a future time, the processor runs the program to apply the rule when that future time arrives.

Another aspect of the present patent application is a system for managing products in an inventory for a dealer, comprising a processor connected to automatically receive input information regarding a plurality of products in the inventory. The processor is connected to run a program to automatically plot a time line of the price as a function of time for the plurality of products in aggregate that includes thereon a plot of a time line of the price as a function of time for an individual one of the plurality of products.

Another aspect of the present patent application is a method of managing products in an inventory for a dealer. The method includes providing time-based rules wherein the time based rules include discounts as a function of time. The method also includes providing rule overrides, wherein the rule overrides provide changes in the time-based rules according to specific business conditions that may arise. The method also includes providing an interface for a dealer to input the rules and the rule overrides.

### BRIEF DESCRIPTION OF THE DRAWINGS

The foregoing will be apparent from the following detailed description, as illustrated in the accompanying drawings, in which:

FIG. 1a is an illustrative example of a list of pricing rules and an illustrative example of a list of pricing rule overrides that may be provided;

FIG. 1b is an illustrative example of a pricing strategy, showing how price changes with time in both a spreadsheet and a graphical representation;

FIG. 2a is a graphical representation of an example of a pricing strategy, showing how price changes with time-based life cycle step for a group of products and the list of products in the group;

FIG. 2b is a graphical representation of an example of a pricing strategy, showing the number of products in each time-based life cycle step for a group of products and the interface for adjusting the rules that set the time and magnitude of price changes;

FIGS. 2c-2d show the graphical representation of FIG. 2b and the use of the interface for adjusting the rules that set the time and magnitude of price changes;

FIGS. 2e-2f shows an illustrative example of a list of products in inventory and detailed information about a selected one of the products on the list and level of interest and activity regarding that product;

FIGS. 3a-3c are illustrative examples of different inventory segments, graphical representations of the time-based profit potential for each segment and of the historical interest over time for each segment as well as showing the number of products in each segment, the level of current interest, and how long ago was the last activity;

FIGS. 4a-4c are illustrative examples of different inventory segments, graphical representations of the time-based profit potential for each segment and a table showing the number of times each of a list of types of interest happened;

FIG. 5 shows the inventory segment of FIG. 3a with a graphical representation of the time-based change in price and of the change in interest over time for that segment as well as showing a list of the products in that segment with details about each member of the list;

FIG. 6 is a block diagram showing how one embodiment of a cloud-based inventory management system integrates with other business tools; and

FIG. 7 is a flow chart showing operation of the program running on the processor in the event a rule is changed, a new product has been added to inventory, or information about a product has changed.

### DETAILED DESCRIPTION

The present applicants created a computer system that applies dealer-set rules to automatically-retrieved market and product information to automatically adjust merchandising actions, such as web-page pricing and advertisement placement. In one embodiment, the system automatically takes into account such market information as calls, personal visits, test drives, and web page views. In another embodiment, the system automatically places advertisements in on-line media mentioning such features as new product availability, manufacturer incentives, and price reduction.

One aspect is a system and a method for a dealer to manage products in an inventory. An interface connected for communication with a processor allows the dealer to provide and adjust rules for running in a program on the processor. The processor is connected to automatically receive input information regarding the products in the inventory. The processor is also configured for running a program for applying the rules to the input information to determine outputs, including merchandising actions. Under the program, the processor automatically selects and implements at least one of the merchandising actions resulting from applying the rules to the input information.

In one embodiment a user provides the rules for running in the program on the processor. The rules may be entered by the dealer manager into a cloud database through a dealer interface, such as an internet connected computer.

One aspect is a scheme that recognizes that inventory value varies with its age. For example, individual items may have the highest profit potential when they are new. Over time inventory takes up resources and may need to be discounted to ‘move’.

As part of the interface of the automated inventory management system, the present applicants designed a timeline, a modified bar chart that displays the average reduction of profit over time for a group of like vehicles. The chart also provides a visual of automated markdown points in vehicle price. The rules are generally designed to reflect the decline in profit over time as modified by other inputs, such as market demand.

In one example, the rules may provide for selecting and implementing a merchandising strategy. In one embodiment the merchandising strategy includes a set of merchandising actions that are triggered by the amount of time the product has been in inventory. For example, a rule may have the processor automatically select and implement a reduction in product price if the product has been in inventory for a specified number of days, such as a 20% price reduction if the product remains unsold in inventory for 7 days then a further 10% price reduction for each week thereafter.

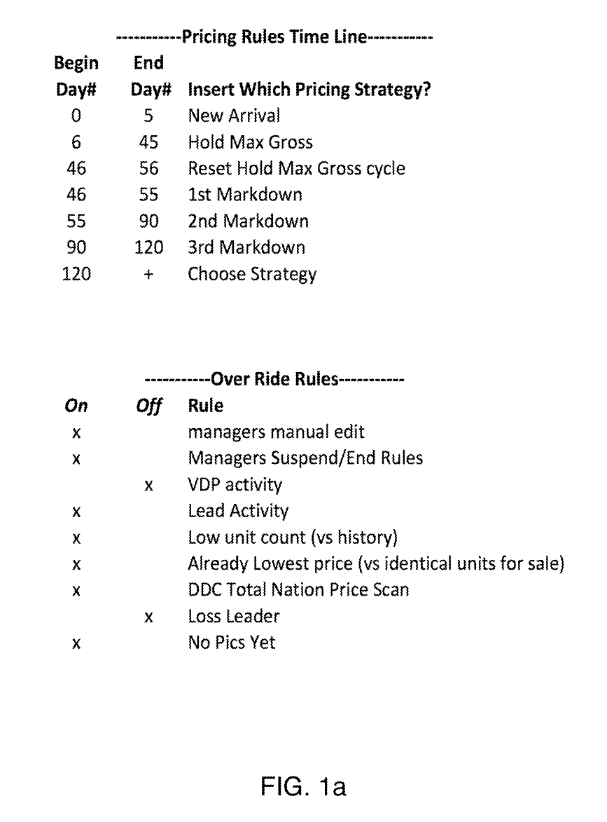

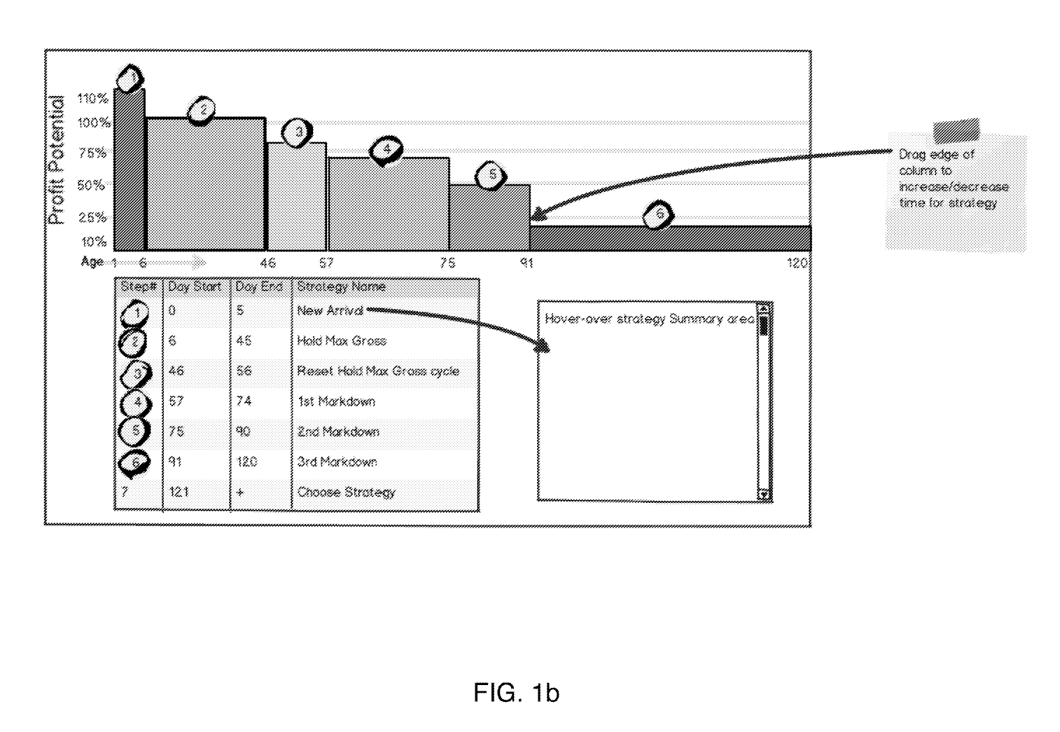

The adjustment can be indicated on a screen available to the dealer in terms of profit potential for a vehicle on a car dealer's lot, as shown in FIGS. 1a-1b. In this example, the program running on the processor runs a strategy set by the dealer with rules setting magnitude and time for each price reduction.

While the embodiment of a car dealer is used in this application, the system described here can be used by a dealer selling any kind of products. Other examples include a retailer and a real estate agency. The system is particularly suitable for dealers with an inventory of products for sale to a consumer.

In one embodiment, the dealer can adjust parameters in the rules in a spread sheet, as shown in FIG. 1a. Alternatively, the dealer can adjust parameters in the rules by clicking and dragging on the graphical representation of the items in the spread sheet, including the time for each price change, either increasing or decreasing the number of days at each price point, as shown in FIG. 1b. In one embodiment, the dealer can also adjust the amount of the price reduction by clicking and dragging on the height of each of steps 1-6.

In the example shown in FIGS. 1a-1b, in step 1 the processor sets a new vehicle arrival price to provide 110% of the normally expected maximum gross profit, and the processor keeps the price set at this level from the day the vehicle arrives at the dealer through day 5. The processor provides this price on a web page describing each of the vehicles at step 1 on the dealer's web site on the internet.

The processor is connected to automatically adjust the price by changing the information on those web pages. In one embodiment, the processor is also automatically connected to send a price sticker to a printer for placement on the vehicle. It is also automatically connected to send an email to a potential customers who have indicated interest in the product. It is also automatically connected to send information about the price change to sales agents.

If the vehicle is unsold and remains in inventory, for vehicles reaching day 6 the program running on the processor automatically reduces the price and changes the price on web pages describing the vehicles, as shown in step 2 in FIG. 1b. In the example, this initial change provides what the dealer would consider to be the full normally expected maximum gross profit potential while the vehicle is on the dealer's lot in inventory from day 6 through day 45.

In this example, the strategy provides that on day 46 the processor automatically lowers the price by a preset percentage or dollar amount if the vehicle is still unsold and on the dealer's lot in inventory on that day, as shown in step 3 on FIG. 1b.

After that, if the vehicle is still unsold, the merchandising strategy run by the processor has three more successive price markdowns, starting on day 57, day 75, and day 91, as shown in steps 4, 5, and 6.

The rules can also provide for what happens to the vehicle after a defined period of time, such as 120 days. One choice of rule that the dealer may select is to post the vehicle to an auction site, such as eBay. Another is be to send the vehicle to auction.

While the price adjustments are automatically applied under the program running on the processor with rules set by the dealer, the program permits the dealer to retain control to override any of the automatic actions the dealer previously set. For example, override rules, or exceptions, allow a dealer manager to enter a particular vehicle's stock number and enter new rules for that vehicle, such as changing a price manually. The processor then resets the price listed on that vehicle's web page.

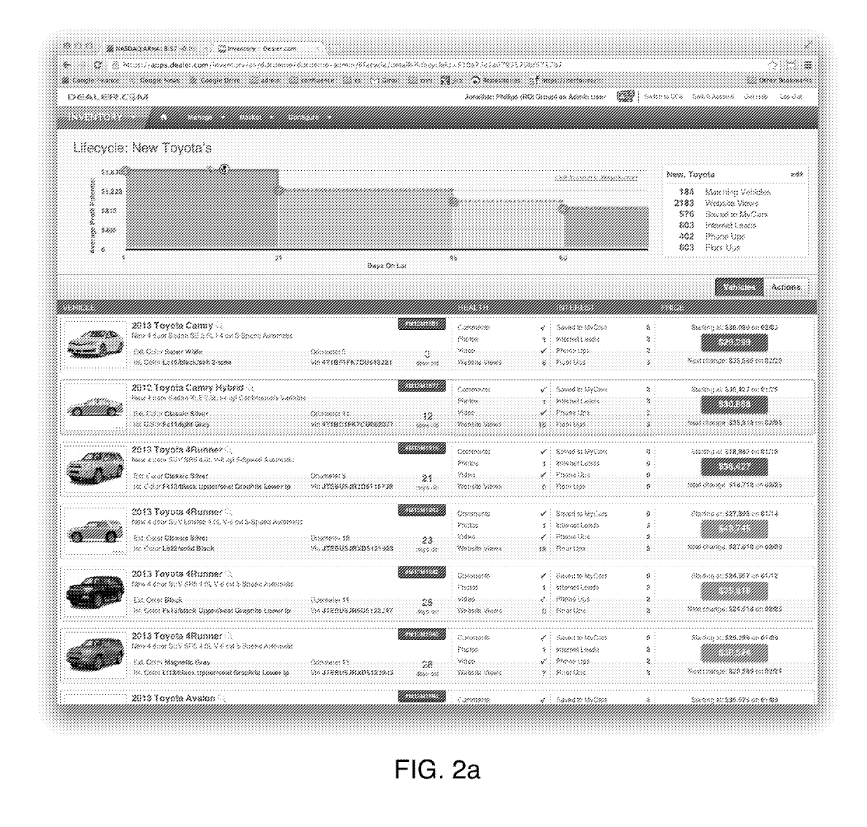

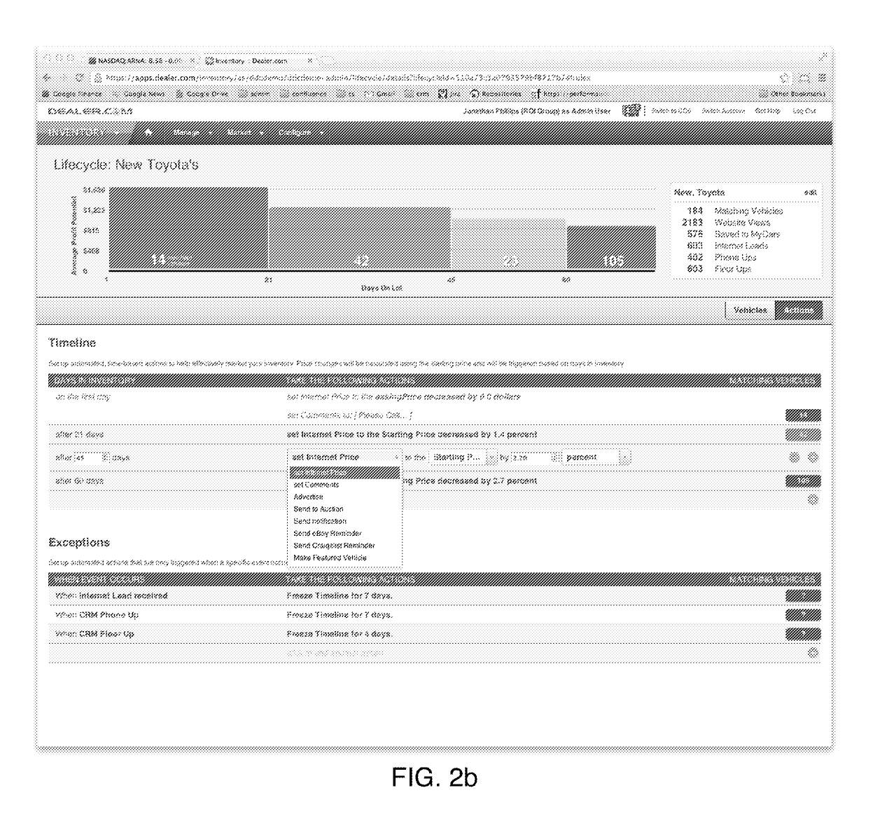

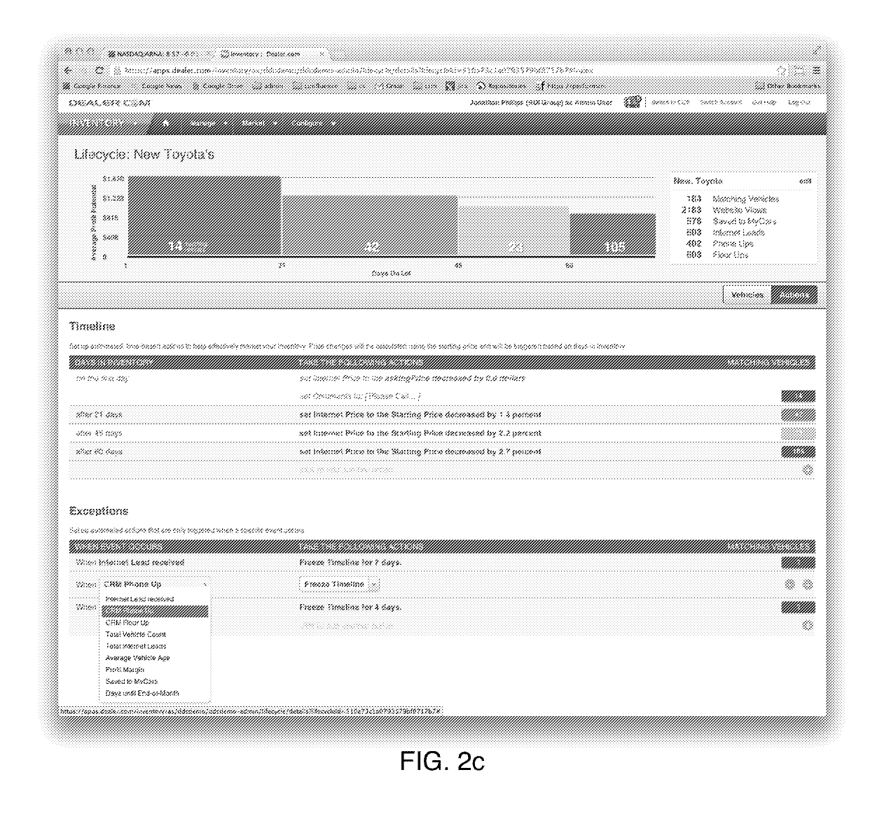

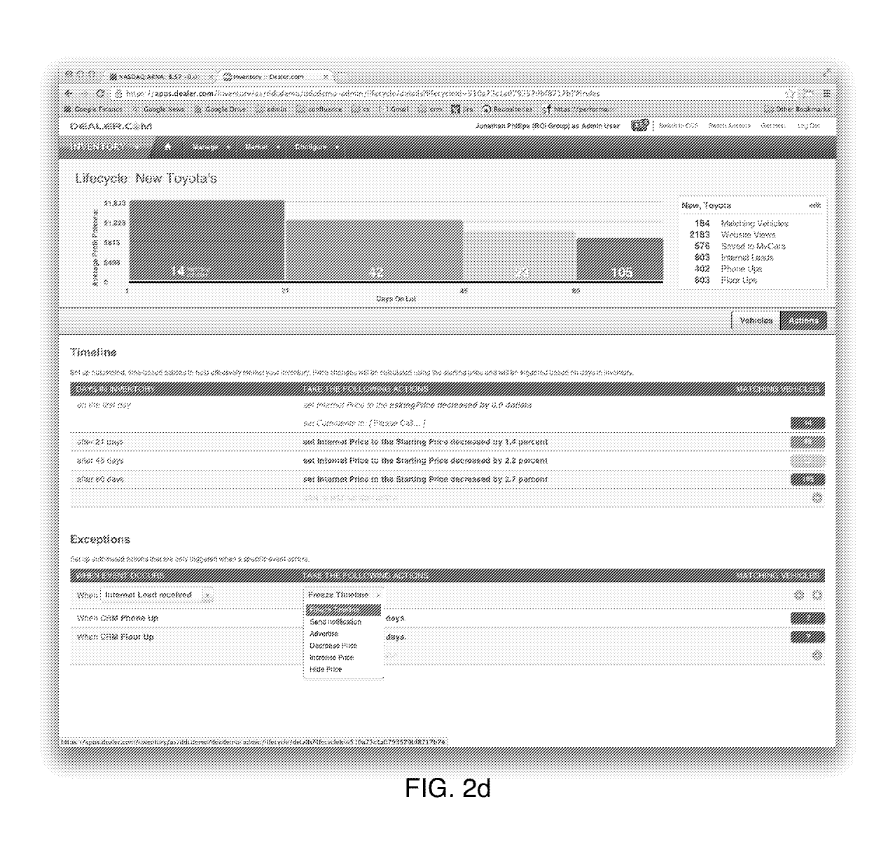

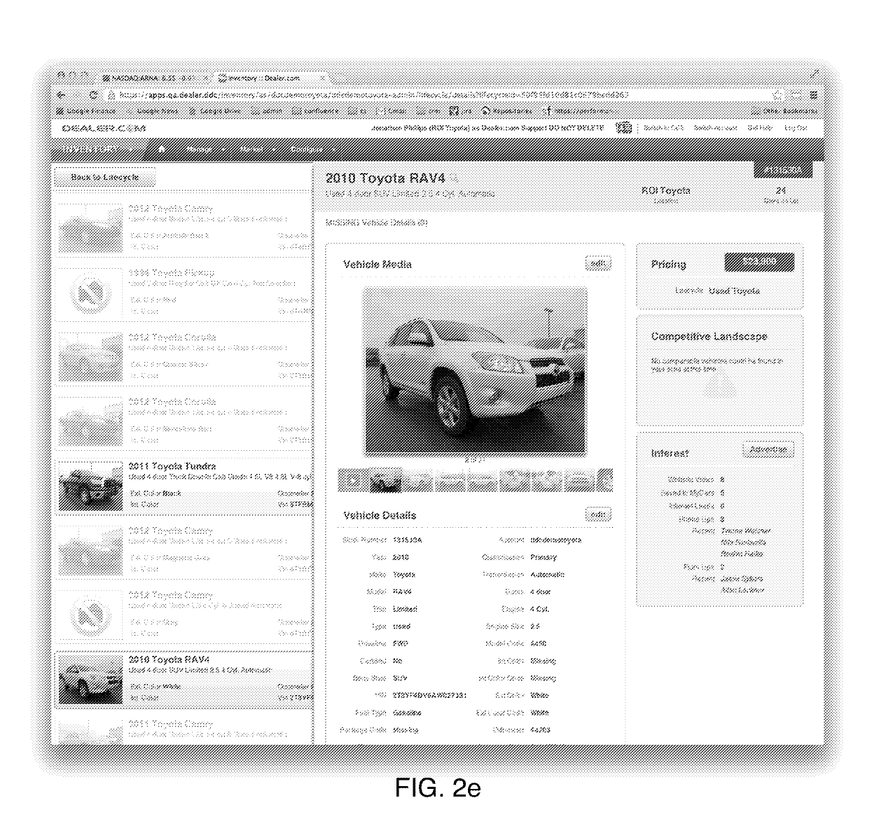

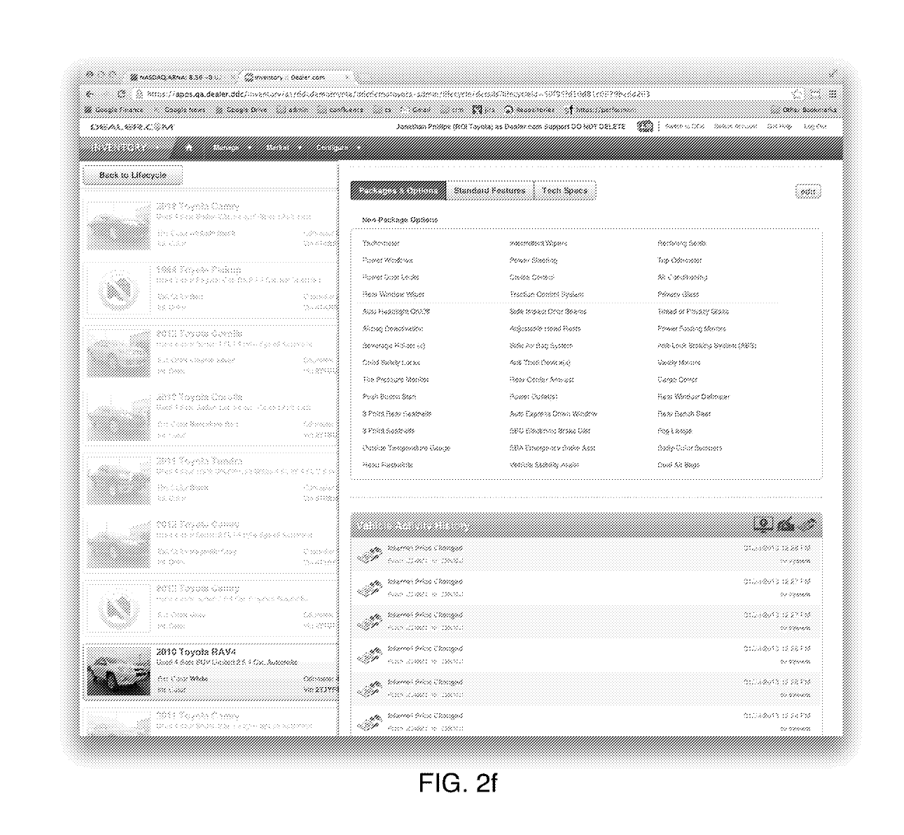

The override rules feature also allows a manager to turn off all scheduled price changes for a vehicle, compare activity on the web page for a particular vehicle with activity for other vehicles in its category, decide not to lower price if number of leads equals or exceeds a specified value, or if supply of that type of vehicle is in short supply, as shown in FIGS. 2c-2d. The override rules feature also allows a manager to avoid lowering the price of the vehicle if it is already the lowest priced vehicle in its category on the dealer lot or the lowest priced compared to vehicles on the market elsewhere. The override rules feature also allows a manager to set one of several identical vehicles as a loss leader, such as by moving that vehicle one step along. The processor takes these override inputs and adjusts schedule, pricing, and other functions accordingly.

The override rules also allow a manager to set other tasks that may provide a lead generating opportunity. For example, a manager may set the processor to send an email to those prospects who viewed a web page for a newly arrived vehicle before photos have been taken. An instruction, such as “If photo=0, then insert ‘missing photo’ lead tool that sends an email to those prospects saying, ‘would you like us to email you when the photos have been taken?’”

Another example with some different information and parameters has automatic price changes at 21, 45, and 60 days, as shown in FIG. 2a for new Toyotas, with average profit potential set at day 1 at $1830, and descending to $1223, $815, and $404. In the embodiment illustrated by this example, a dealer can see aggregate input information for the entire segment, including the number of matching vehicles, number of prospects who viewed a vehicle's web site, number of web site viewers who saved one of the vehicles for later viewing, number of internet leads, number of phone calls, and number of people who appeared on the dealer floor to see any of the vehicles.

Details about each vehicle in the segment and its merchandising are also shown as rows of information, one row for each vehicle. Such information is included for each vehicle as year, make, model, new or used, doors, engine, transmission, exterior and interior color, odometer reading, VIN number, and how many days the vehicle has been on the dealer's lot. This embodiment also provides information about the contents of each vehicle's web page including whether photos of the vehicle and a video have been uploaded to the website or still need to be uploaded and whether a video has been generated. It also shows the level of interest shown by prospects, including the number of website views and whether comments have been input by viewers, the number of web site viewers who saved that vehicle for later viewing, the number of internet leads, the number of phone calls about that vehicle, and the number of people who appeared on the dealer floor to see that vehicle. The initial price, the current price, the date of the next price change, and the date of that price change are also shown for that vehicle.

In another view available under the present scheme, the processor can display the number of vehicles in each life cycle step, as shown in FIG. 2b. This provides a dealer with immediate feedback as to the number of vehicles affected by the rules chosen.

Also shown on the screen in FIG. 2b is the interface that allows a dealer manager to set the rules, including the times for price reductions and the magnitude of those reductions. The screen provides for the manager to set other actions, such as adding comments about the vehicle to the vehicle's web page, setting advertising, sending to auction, sending notifications to potential customers and sales personnel, sending a reminder to the dealer to complete the submission of a vehicle to eBay or Craigs list, and making one of the vehicles a featured vehicle, such as by providing a featured vehicle attribute to the vehicle that highlights the vehicle on its web site. The screen also provides for the manager to input exceptions, such as holding off scheduled price reductions for a specified number of days after a lead, phone call, or test drive. The screen in FIG. 2b also shows the number of vehicles affected by the rules so provided.

Other variables that can provide basis for action, such as total vehicle count in the segment, average vehicle age, profit margin, number saved by prospects, and days until end of month, as shown in FIG. 2c, can provide for scheduling actions, such as freezing the time line to prevent a scheduled event, such as a price reduction, sending notifications, advertising, decreasing or increasing the price, or hiding the price, as shown in FIG. 2d.

In this embodiment, details about the vehicle and its merchandising can be seen in FIGS. 2e-2f by a manager by clicking on that vehicle in a listing, such as the one shown in FIG. 2a. The vehicle details, photographs, pricing, level of interest, packages and options, and dates and times of all activity related to that vehicle are shown.

Instead of—or in addition to—the dealer-set price change strategy that automatically runs on the program and is executed by the processor, the program may include a rule that would have the processor automatically select and implement advertising for a product or products in inventory. Product advertising can be automatically created and transmitted to an online advertising medium, such as commercial web sites, search engines, display advertising networks, and/or social networks. Sites include Google Search, Google Display, Mobile and Youtube, Facebook Display, Facebook Promoted Posts, Facebook Promotions, and Yahoo. It can also be used in email marketing campaigns.

The automatically created advertisement can include a picture and list specific features of the vehicle, such as make, model, year, mileage, engine, transmission, color, and current price. It may also be transmitted to traditional advertising media, such as a magazine, or a newspaper. Versions can also be transmitted to a radio or TV station.

As described in commonly assigned U.S. Pat. No. 8,112,279 (“the '279 patent”), issued Feb. 7, 2012, and incorporated herein by reference, audio may be automatically generated by the processor by stitching together short segments of prerecorded audio to describe any specific vehicle using data stored online and available based on the vehicle identification number and other inputs that may be provided by a dealer. This automatically generated audio can be used in an advertisement run on the vehicle's web page, elsewhere on the internet, or on the radio. In addition, the audio automatically generated that describes photographs on the website and other aspects of the vehicle can be used to generate an audio visual advertisement that run on the vehicle's web page, elsewhere on the internet, or on TV.

Automated actions that may be taken by the processor under program control include:
increase or decrease the price listed on the web page a specified dollar amount or percentage or hide the price on the web page.
add comments, images, and/or video to the vehicle's web page
promote inventory on dealership property, for example by creating a manager's special on the dealer website
digital advertise, for example by automatically creating and transmitting display and/or search ads to advertising web sites.
sending notifications to dealership staff, such as by email or text message
Sending notifications to consumers interested in similar inventory
exporting an item in inventory to another destination, such as eBay or AutoTrader
sending an item in inventory to auction
removing an item from inventory

In one embodiment, inputs automatically retrieved by the processor include at least one of the following: product identification, a parameter related to current price, a parameter related to current demand, pricing by competitors, manufacturer information, weather conditions, calendar date, holidays, and special events.

In one embodiment, the parameters related to product identification are retrieved from an online data base based on the vehicle identification number (VIN). The information obtained based on VIN includes year, make, model, engine, transmission, interior and exterior color, door style, features and options. Input information can also include data previously input to a database by the dealer, such as mileage, vehicle condition, and special dealer incentives. The VIN number is obtained from an inventory feed in which the dealer uploads a file over internet to a cloud system with a list of the items in inventory, including VIN numbers.

The parameter related to current demand may be determined automatically from a count of the number of physical customers, the number of callers, the number of digital viewers, the number testing the product, the number of offers to purchase, the number penciling financing, the number closing a deal, and/or the number unwinding the deal. A single indication of current demand may be obtained by weighting the importance of each of these individual factors.

For example, inputs available on line in the cloud database operated by Dealer Dot Com, Inc. include:

Digital Interest
page views/clicks by viewers collected from web analytics
a consumer adding an item to a wish list
requests for more information, such as email form submissions containing contact information
social sentiment, such as Facebook likes

Physical Interest
consumer phone calls to the dealership
consumers walking into the dealership, for example to test driving a vehicle
negotiation
sold or lost deal

Market Competitive Data
supply and pricing data of comparable vehicles in the region

Manufacturer Data
cash incentives and lease terms, such as a particular annual percentage rate
warrantee information
certified pre-owned status

Characteristics of the Inventory Itself
physical location
options, color, mileage, price
length of time the item has been in the dealer's inventory
service history
reviews
marketability/health indicators, such as missing images, video, and comments

Characteristics of the Dealership
total inventory size
average vehicle age
sales staff availability
sales incentive plans and goals

General
current weather
calendar dates, time of week, month, year
holidays

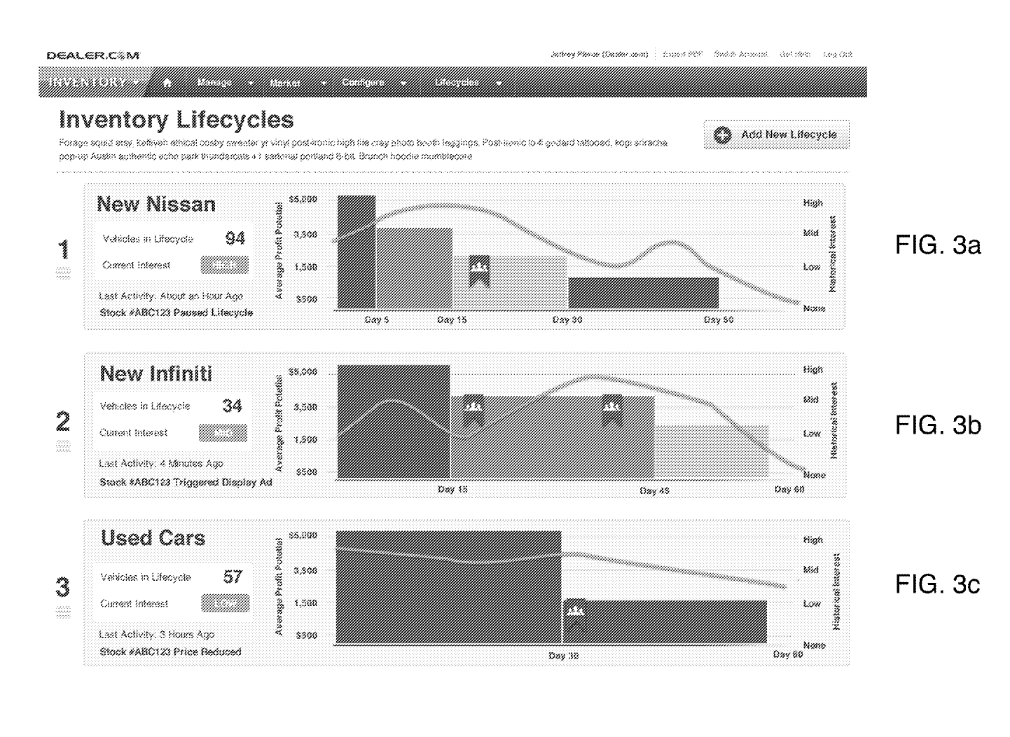

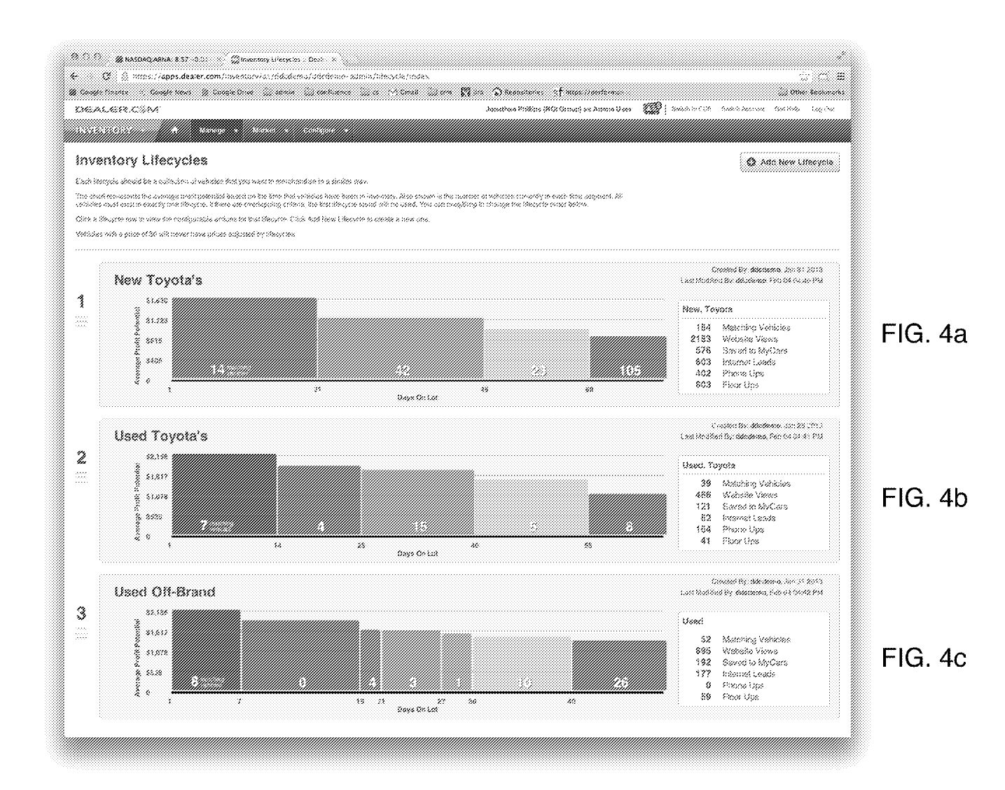

In one embodiment, the inventory may be considered to have inventory segments, as shown in FIGS. 3a-3c and in FIGS. 4a-4c. One or more different strategies, also called life cycles or sets of rules, may be provided for each of the three inventory segments shown. In the example, the three inventory life cycles, corresponding to three different sets of rules, shown are for three vehicle segments. The charts track both the pricing strategy for each vehicle segment and the historical interest level changes over time. The charts also show the number of vehicles in each segment, the time of the last activity, the last activity automatically taken, and the number of the vehicle in the dealer's stock. In another version, segments can be such that each product in the inventory has its own rules.

In the example, the first segment includes 94 new Nissan vehicles, as shown in FIG. 3a. Automatic information inputs to the processor uploaded from the web pages of each vehicle indicate that the average current interest in this segment is high. The pricing strategy set by the dealer for this segment includes 4 price points with price changes occurring at days 5, 15, and 30. The 94 new Nissan vehicles are distributed among all 4 price points depending on their various arrival dates at the dealer location.

For each segment, the bars indicate the average price of all the vehicles as they pass through that time frame.

The second segment includes 34 new Infiniti vehicles, as shown in FIG. 3b. Automatic information inputs to the processor indicate that the current interest is medium. The pricing strategy for this segment includes 3 price points with price change occurring at days 15, and 45.

For the third segment, used cars, automatic information inputs to the processor indicate that the current interest is low, as shown in FIG. 3c. The pricing strategy for this segment includes 2 price points with price change occurring at day 30.

Business conditions, including changes in interest level, may be used in overrides of rules to adjust dates and magnitudes of price changes for individual vehicles. For example, if interest in a vehicle is high, the scheduled price reduction may be delayed.

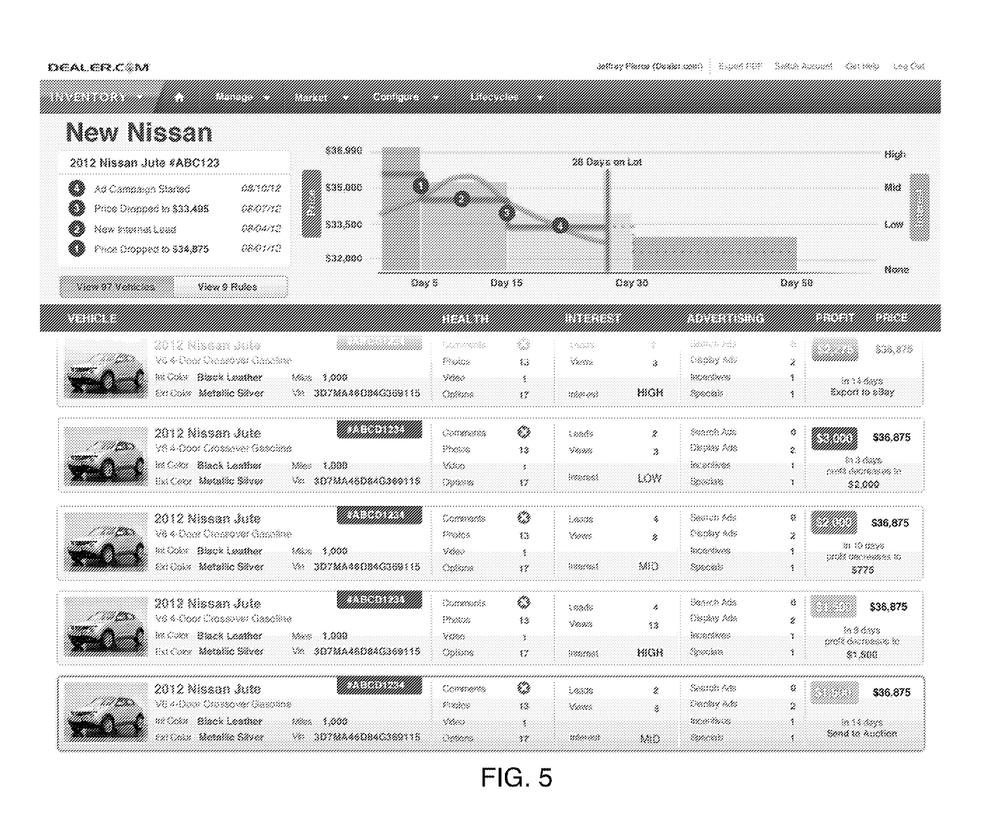

A list of some of the new Nissan vehicles in the first segment and information about each vehicle is shown in FIG. 5, along with more details about a particular vehicle in the segment. Price for a particular vehicle depends on factors, such as its standard and optional equipment, its mileage, and its condition, as also shown in FIG. 5. The history of events for that specific vehicle is presented in relation to the life cycle for its segment of vehicles. For this vehicle, the initial price was below average for its segment of new Nissans and its particular price reductions followed from that initial price according to a percentage reduction schedule common to the segment, as shown with solid lines 1, 2, 3, 4. Its projected price going forward from its current 28 days on the dealer's lot are indicated by dotted lines. Any other difference in line type can be used for showing past and future times, such as different colors. Actions automatically taken or recorded by the processor are shown at each of the four points, such as price dropped to $34,875 on Aug. 1, 2012, a new internet lead on August 4, the price dropped to $33,495 on August 7, and an ad campaign started on August 10. These events are highlighted with numbers on a graphical representation. The number of rules in the merchandising strategy is also given.

Information about each vehicle includes model year, model name, engine, doors, interior and exterior colors, mileage, vehicle identification number, and stock number. Marketing information for each vehicle is also shown, including how rich the information and media is on the web site, interest level, advertising, profit, and price. Health includes photos, video, and options that may be viewed on the web page for the vehicle. The processor is programmed to automatically notify the dealer manager when any inventory item is lacking information or media. The processor can generate information and media using the technology described in the '279 patent. Interest includes leads and views. An overall determination of interest can be obtained by weighting individual factors. Advertising includes number of search ads, display ads, incentives, and specials. Under the profit and price categories, the time to the next merchandising action is shown along with indication of what that merchandising action will be, such as export to eBay in 14 days or profit decreases to $2000 in 3 days.

Another aspect of this patent application is a system for coordinated managing of pricing and advertising of products in an inventory for a dealer. The system includes a processor connected to receive input information regarding a product in the inventory. The processor is configured to run a program to apply a rule to the input information regarding adjusting product pricing and placing product advertising based on the input information. The processor is programmed and connected to automatically implement a change in product pricing and to automatically place a product advertisement in the advertising medium.

The processor applies the rules to both adjust product pricing and to place product advertising in conjunction with each other based on the input information. Examples of such ruler include: In view of inputs reflecting low interest, maintaining a price while running an advertising campaign. In view of inputs reflecting continued low interest, lowering the price while advertising the new lower price. In view of inputs reflecting a high number of website hits and test drives, omitting an advertisement. Thus, price and advertising strategy can be set and automatically implemented by the processor for specified periods of time depending on specified input variables according to rules set by the dealer.

In one embodiment data is collected and stored by the processor correlating sales with product pricing and product advertising actions. A rule or rules can then be adjusted based on the data collected. The rule-adjusting may be to optimize pricing and advertising based on the data collected.

Another aspect of this patent application is a system for managing products in an inventory for a dealer that uses the processor to automatically receive input information regarding a business condition for a product in the inventory. The processor is connected to run a program to automatically select from merchandising actions for the product based on the business condition for the product, and to automatically implement at least one of the merchandising actions.

In one embodiment, the business condition includes consumer interest in the product. Business condition also includes competitive pricing, manufacturer incentive, and events, such as a 4^{th} of July sale. The consumer interest in the product may include the number of consumers digitally watching the product. The consumers digitally watching the product may include those who provide an email address indicating desire for alerts regarding the product, return a form, make a call, offer a bid, and/or add to a wish list on the website of the dealer.

Another aspect of this patent application is a system for managing products in an inventory for a dealer that uses the features described herein above, including the processor, the dealer interface, and a database in which the dealer enters rules, the processor retrieves input information, and the processor adjusts merchandising actions based on applying the rules to the information. In this aspect the dealer interface displays how the merchandising actions for members of the inventory change with time under the rules.

The present system of inventory management may be integrated with other systems, such as customer relationship management software, such as CRM, that dealers may use to manage their day operations, including appointments, emails, penciling financial agreements, entering sales data, and recording information about test drive, calls, and web site hits.

One embodiment of the present system allows a dealer to make changes to the records of vehicles in inventory, such as packages and options that a vehicle actually has, mileage, and vehicle condition. It also allows the dealer to upload images, and enter and upload rules for the inventory management system.

An advertising configuration and deployment interface in the inventory management system allows the dealer to configure and deploy automatic advertising campaigns, pick ad templates for display ads, pick search terms, create the ad text, pick a picture of the vehicle, set up a schedule for an ad campaign and budget for Google ads and ads on other web sites and to use the templates and campaigns they set up. The inventory management system has accesses to digital property, such as web sites of products and/or Facebook, allowing ready access to inventory for viewing.

The inventory management system allows reporting such as by a dealer logging in and putting in queries to find out how business is performing, obtain leads from the website, see how many items were sold, and get reports on customer interest, sales agent performance, price changes, advertisements run, and effectiveness of ads, such as how many clicks are being obtained from search and display advertisements. The data collected may be used to refine rules and optimize pricing and advertising. The data may also be used to gain longer term insights across the industry.

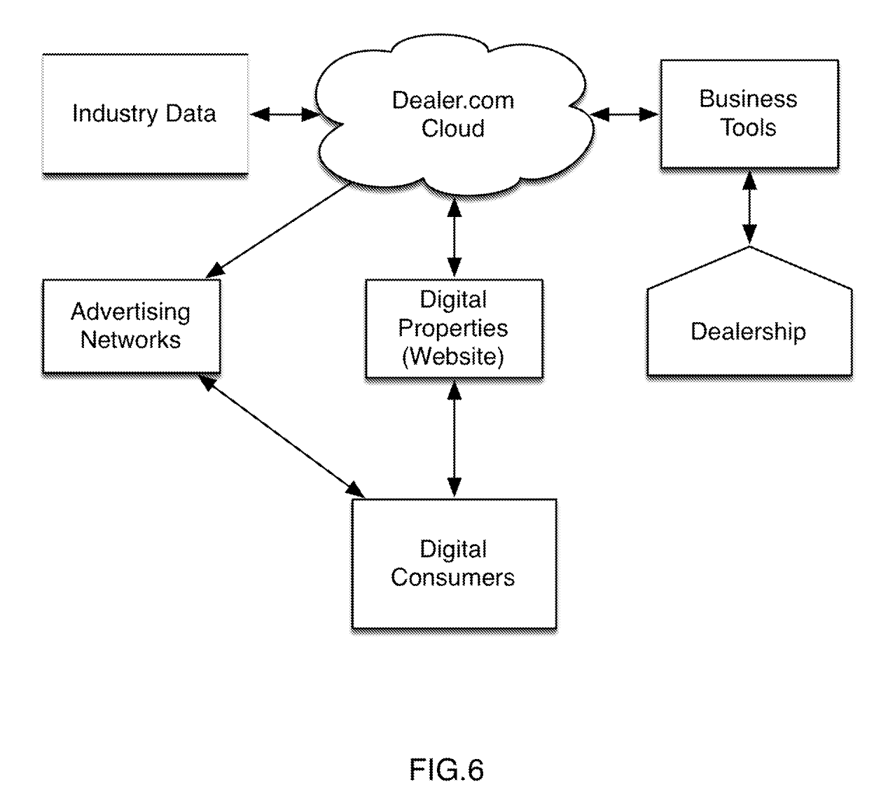

A cloud based inventory management system integrates with other business tools to provide and save inputs from dealerships, industry data, data from digital properties, and data from advertising networks, to schedule changes or events, such as price changes and advertising for a particular product, as shown in FIG. 6.

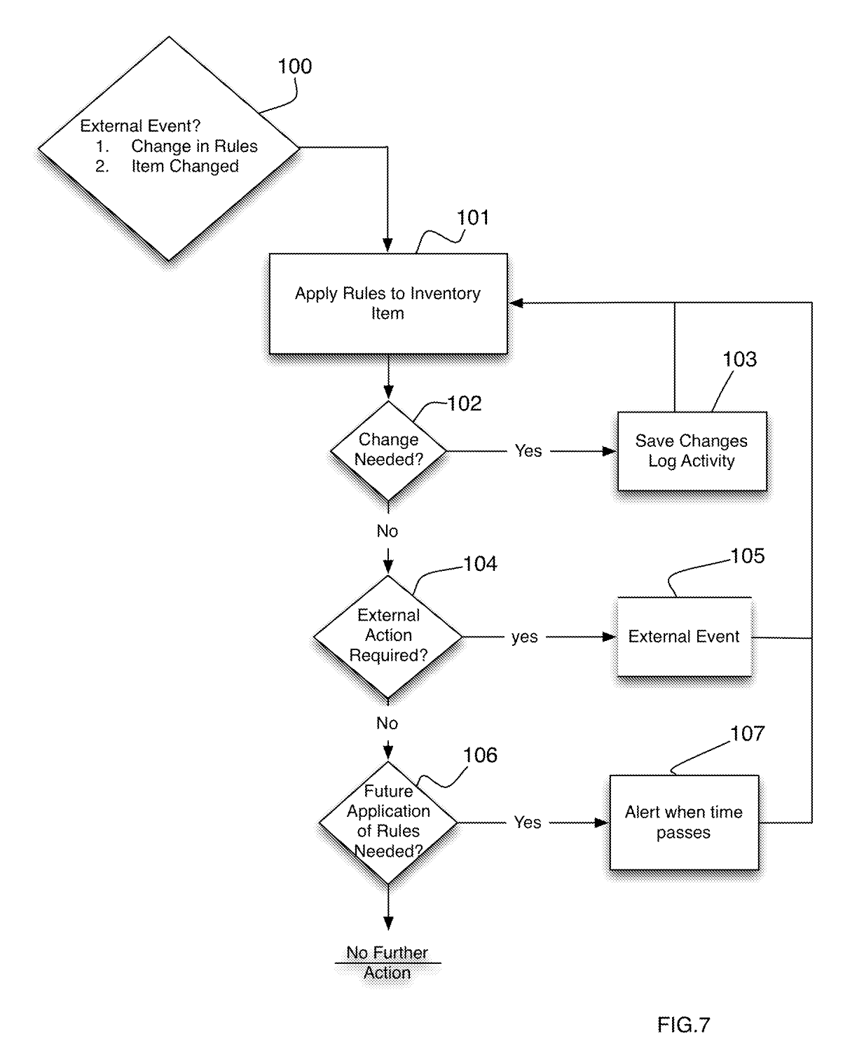

In operation, in one embodiment of the system, the processor determines whether a change in rules has been saved or a new vehicle has been added to inventory or whether inputs about an item has otherwise changed in inventory, such as digital interest in the vehicle, manufacturer information, or competitive pricing, as shown in box 100 of FIG. 7. If so, the processor applies the rules to the inventory item, as shown in box 101. If a change in internal merchandising, such as pricing, placing comments on the vehicles web site, or featuring the vehicle, is called for by the rules, as shown in box 102, the change is made and logged, as shown in box 103. The processor then considers whether an external action is called for by the rules, as shown in box 104, such as advertisement placement, syndication to a commercial web site, or sending the vehicle to auction. If so, that external action is taken, as shown in box 105, and the event logged. The processor then considers whether a future application of the rules is called for and when, as shown in box 106. If so, an alert is provided, as shown in box 107, so when the time for that future application of the rules arrives the processor applies the rules to the item in inventory, restarting the process in box 101.

In one embodiment, input information about a vehicle is stored in a storage medium, such as a data base, and the input information can then be retrieved from the storage medium and reused if, for example, the vehicle is traded-in and put on sale again.

In one embodiment, the definition of the rules set by the dealer is simplified by the interface which organizes rules into two categories: time based rules and rule overrides or exceptions. The time based rules can include a first-day rule or rules that establish a starting price and initial actions, such as comments. The based rules also include discounts along a time line and other merchandising actions, such as advertising. The rule overrides or exceptions allow dynamically merchandising according to specific business conditions that may arise, such as an increase in digital interest, a change in competitive pricing, and a customer initiating a potential sale.

While several embodiments, together with modifications thereof, have been described in detail herein and illustrated in the accompanying drawings, it will be evident that various further modifications are possible without departing from the scope of the invention as defined in the appended claims. Nothing in the above specification is intended to limit the invention more narrowly than the appended claims. The examples given are intended only to be illustrative rather than exclusive.

What is claimed is:

1. A method for a dealer to manage products in an inventory, comprising:
a. providing an interface and a processor, wherein said interface is connected for communication with said processor, wherein said interface and said processor are configured so the dealer can provide a plurality of rules through said interface for running on said processor, wherein said processor is configured for running a program for applying said rules to input information that may be provided to said processor regarding a product in the inventory, wherein outputs of said running said program applying said rules include at least one merchandising action regarding a product in the inventory; and
b. wherein said processor is connected to automatically receive said input information, wherein said processor is configured for running a program to automatically implement said at least one merchandising action resulting from applying said rules to said input information.

2. The method as recited in claim 1, further comprising:
a. providing said plurality of rules for running on said processor; and
b. automatically providing said input information regarding the product to said processor, running said program on said processor, and automatically implementing the at least one merchandising action regarding the product.

3. The method as recited in either of claim 1 or 2, wherein said at least one automatic implementing merchandising action varies as a function of time the product is in inventory.

4. The method as recited in any of the previous claims, wherein said at least one automatic implementing merchandising action adjusts product price.

5. The method as recited in any of the previous claims, wherein said at least one automatic implementing merchandising action automatically transmits product advertising copy.

6. The method as recited in claim 5, wherein said automatic transmission of product advertising copy is to at least one from the group consisting an advertising medium and an email marketing campaign.

7. The method as recited in any of claims 1-3, wherein said at least one automatic implementing merchandising action sends the product to an auction.

8. The method as recited in any of the previous claims, wherein said plurality of inputs includes at least one from the group consisting of product identification, a parameter related to current price, a parameter related to current demand, pricing by competitors, manufacturer information, weather conditions, calendar date, holidays, and special events.

9. The system as recited in claim 8, wherein said parameter related to current demand includes at least one from the group consisting of number of physical customers, number of callers, number of digital viewers, number testing the product, number of offers, number penciling financing, number closing a deal, and number unwinding the deal.

10. The method as recited in claim 8, wherein said manufacturer information includes at least one from the group consisting of manufacturer incentive, product supply, and warrantee information.

11. The method as recited in any of the previous claims, wherein said inventory includes a plurality of inventory segments, further comprising providing at least one different rule for each of said inventory segments.

12. The method as recited in any of the previous claims, further comprising providing a storage medium for said input information, further comprising storing said input information for possible retrieval for a subsequent sales event, further comprising retrieving said input information from said storage medium for the subsequent sales event.

13. The method as recited in any of the previous claims, further comprising collecting data correlating sales with product pricing and product advertising actions.

14. The method as recited in any of the previous claims, further comprising adjusting said rule based on said data collected.

15. The method as recited in any of the previous claims, wherein said adjusting said rule is to optimize pricing and advertising based on said data collected.

16. A system for managing pricing and advertising of products in an inventory for a dealer, wherein the advertising is in an advertising medium, comprising a processor connected to receive an input information regarding a product in the inventory and wherein the processor is configured to run a program to apply a rule to said input information, wherein the rule regards at least one from the group consisting of adjusting product pricing and placing product advertising based on the input information, wherein the processor is programmed and connected to automatically implement a change in product pricing and wherein the processor is connected to automatically place a product advertisement in the advertising medium.

17. The system as recited in claim 16, further comprising an interface, wherein said interface and said processor are configured so the dealer can provide said rule through said interface for running on said processor.

18. The system as recited in any of claims 16 and 17, wherein the processor is configured to run a program to apply a plurality of said rules to said input information, wherein said rules provide outputs regarding adjusting product pricing and placing product advertising based on the input information.

19. The system as recited in any of claims 16-18, wherein said input information includes at least one from the group consisting of product identification, a parameter related to current price, a parameter related to current demand, pricing by competitors, manufacturer information, weather conditions, calendar date, holidays, and special events.

20. The system as recited in claim 19, wherein said parameter related to current demand includes at least one from the group consisting of number of physical customers, number of callers, number of digital viewers, digital interest, number testing the product, number of offers, number penciling financing, number closing a deal, and number unwinding the deal.

21. The system as recited in any of claims 16-20, wherein said rule includes setting a parameter related to price for a specified number of days if a specified input occurs.

22. The system as recited in claim in any claims 16-21, further comprising collecting data correlating sales with product pricing and product advertising actions.

23. The system as recited in any of claims 16-22, further comprising adjusting said rule based on said data collected.

24. The system as recited in any of claims 16-23, wherein said adjusting said rule is to optimize pricing and advertising based on said data collected.

25. A system for managing products in an inventory for a dealer, comprising a processor connected to automatically receive input information regarding a business condition for a product in the inventory, wherein the processor is connected to run a program to automatically select from a plurality of merchandising actions for the product based on the input information regarding a business condition for said product, wherein the processor is connected to automatically adjust at least one of said merchandising actions based on said input information.

26. The system as recited in claim 25, wherein the input information regards consumer interest in the product.

27. The system as recited in claim 26, wherein the consumer interest in the product includes number of consumers digitally watching the product.

28. The system as recited in claim 27, wherein the consumers digitally watching the product includes at least consumers from the group consisting of those listing an email indicating desire for alerts regarding the product, returning a form, making a call, offering a bid, and adding to a wish list.

29. A system for managing products in an inventory for a dealer, comprising a processor, a dealer interface, and a database, wherein said processor is connected to said dealer interface and to a source of input information, wherein said processor is connected for adjusting merchandising actions, wherein said dealer interface is configured for a dealer to enter rules into said database, wherein said dealer interface is configured to display how merchandising actions for members of the inventory change with time under said rules.

30. The system as recited in claim 29, wherein said connection for adjusting merchandising actions includes connection to an external digital location for advertising.

31. The system as recited in any of claims 29 and 30, wherein said source of input information includes information about at least one from the group consisting of a physical customer, digital viewers, competitive pricing, manufacturer information, weather conditions, calendar time, holidays, and special events.

32. The system as recited in any of claims 29-31, wherein said manufacturer information includes at least one from the group consisting of incentives, vehicle supply, and warrantee.

33. A system for managing products in an inventory for a dealer, comprising an interface and a processor, wherein said interface is connected for communication with the processor, wherein the interface and processor are configured so the dealer can provide a plurality of rules through the interface for running on the processor, wherein the processor is connected to automatically receive input information, wherein the processor is configured for running a program for applying the rules to the input information that may be provided to the processor, wherein outputs of the rules include merchandising actions regarding a product in the inventory, wherein the processor is programmed and connected to automatically implement at least one of the merchandising actions resulting from applying the rules to the input information.

34. A system for managing products in an inventory for a dealer, comprising a processor connected to automatically receive input information regarding a product in the inventory, wherein the processor is connected to run a program to automatically apply a rule to said input information, wherein the processor is connected to run a program to automatically determine whether a next future application of the rule is planned, and if a next future application of said rule is planned for a future time, said processor runs said program to apply said rule when that future time arrives.

35. The system as recited in claim 34, wherein said next future action includes at least one from the group consisting of a price adjustment and placing an advertisement.

36. A system for managing products in an inventory for a dealer, comprising a processor connected to automatically receive input information regarding a plurality of products in the inventory, wherein the processor is connected to run a program to automatically plot a time line of the price as a function of time for said plurality of products in aggregate that includes thereon a plot of a time line of the price as a function of time for an individual one of said plurality of products.

37. The system as recited in claim 36, wherein said plot of a time line of the price as a function of time for an individual one of said plurality of products includes a different line type for past and future times.

38. A method of managing products in an inventory for a dealer, comprising
a. providing time-based rules wherein said time based rules include discounts as a function of time;
b. providing rule overrides, wherein said rule overrides provide changes in said time-based rules according to specific business conditions that may arise; and
c. providing an interface for a dealer to input said rules and said rule overrides.

39. The method as recited in claim 38, wherein said rules include a first-day rule that establishes a starting price.
